(19) United States
(12) Patent Application Publication
(10) Pub. No.: US 2015/0343895 A1
(43) Pub. Date: Dec. 3, 2015

(54) FUEL SUPPLY SYSTEM

(71) Applicant: NIKKI CO., LTD., Kanagawa-ken (JP)

(72) Inventor: Kazuki Kimura, Kanagawa (JP)

(21) Appl. No.: 14/293,595

(22) Filed: Jun. 2, 2014

(51) Int. Cl. B60K 15/01

(52) U.S. Cl. CPC B60K 15/01

(57) ABSTRACT

To provide a fuel supply system in which fuel stored in a fuel storage tank 12 formed in a housing main body 11 can be supplied by a high-pressure pump 3 provided in the housing main body 11 in spite of a rapid acceleration or a rapid deceleration of an engine, two types of connectors, which is a first connector 4 having a low-pressure pump 41 having a connection port for a fuel supply pipe from a fuel tank and a second connector 5 having no pump, can be selectively attached via a common connector mounting part formed on a wall surface 14 of a housing body 11, and by using a housing 1 having therein the commonly used high-pressure pump 3, a fuel supply system using an external pump and a fuel supply system using no external pump can be respectively manufactured in accordance with the purpose of use.

### BACKGROUND OF THE INVENTION

The present invention relates to an improvement of a fuel supply system provided in the middle of a fuel supply pipe, as described in U.S. Pat. No. 6,390,871 and JP 2013-516576 W (PCT/US2011/020454), to supply liquid fuel stored in a fuel tank to an engine.

When supplying the liquid fuel stored in the fuel tank to the engine, it is necessary to continuously supply fuel even if there is a rapid acceleration or a rapid deceleration, and it is also necessary to prevent evaporation of the fuel due to high temperatures generated by operation of the engine.

In order to address this issue, conventionally, U.S. Pat. No. 6,390,871 proposes an engine control module equipped with two pumps in a reserve tank, for example. This engine control module is provided in the reserve tank with a first fuel pump as a draw-up pump for drawing up the fuel from a fuel tank to a reserve tank and a second fuel pump for feeding the fuel drawn-up into the reserve tank into a fuel rail of the engine at a higher pressure; thus, the engine control module has advantages of saving pipes for a fuel pipe, easy manufacturing, and further prevention of fuel leakage. However, this prior art has two fuel pumps disposed in the reserve tank, and thus has issues that assembly and mounting are cumbersome and the production cost is high.

In order to solve these problems, JP 2013-516576 W (PCT/US2011/020454) proposes a vapor separator (fuel pump). As shown in FIG. 7, a vapor separator (see FIG. 7) is proposed in which there is disposed in the reserve tank RT a high-pressure pump P2 for feeding the fuel drawn-up in the reserve tank RT into the fuel rail of an engine at a higher pressure and there is disposed a low-pressure fuel pump P1 which is constituted by a pulse pump for drawing up the fuel from the fuel tank to the reserve tank RT and is integrally formed on the outside of the reserve tank RT, for example; thus, the vapor separator can be assembled more easily and be provided at a lower price.

However, this fuel supply system (vapor separator) is a system, in which the pulse pump as the low-pressure pump P1 is formed on a housing H having the reserve tank RT integrally and indivisibly, and which has to have two pumps; thus, there is a big problem that the fuel supply system cannot be applied to a system which supplies a sufficient amount of fuel to the engine by using, for example, the reserve tank RT and the second high-pressure pump P2 even when the rapid acceleration or the rapid deceleration occurs.

### BRIEF SUMMARY OF THE INVENTION

The present invention relates to improvement to a conventional fuel supply system having a reservoir provided in the middle of the fuel supply pipe to supply the stored liquid fuel in the fuel tank to the engine, and an object of the invention is to provide a fuel supply system which is useful for many purposes and is excellent in cost.

The present invention includes: a housing configured to have a lid body airtightly covering an opening formed in an upper surface of a housing main body which forms a fuel storage tank which doubles as a reservoir, and configured to have, in a sidewall of the housing main body, a fuel intake port communicating with the fuel storage tank; a high-pressure pump provided in the housing main body to supply fuel stored in the fuel storage tank to an engine; and a connector which is integrally attachable to the sidewall of the housing main body, the connector including: a fuel-feeding port configured to be in touch with and communicate with the fuel intake port formed in the wall surface when the fuel-feeding port is attached to the sidewall; and a connection port configured to communicates with the fuel-feeding port and to accept a fuel supply pipe from a fuel tank, wherein the connector includes a two types of connectors including a first connector having a low-pressure pump and a second connector having no pump, and wherein the two types of connectors is selectively attachable via a common connector mounting part formed on the sidewall of the housing main body. Thus, by using a common housing in which a high-pressure pump is installed, a fuel supply system using an external pump and a fuel supply system using no pump can be manufactured.

Further, a configuration is made such that in the fuel storage tank formed in the housing main body, there is provided a float having a regulator function for keeping a liquid surface of the fuel stored in the fuel storage tank at a predetermined position; thus, the regulator function can be installed in a small space.

Further in the present invention, the fuel intake port formed in the wall surface of the housing main body is formed above a liquid surface of the stored fuel; thus, even in the case that the external pump is not used, the fuel can be taken in, by free fall, from the fuel tank into the fuel storage tank formed in the housing main body.

The high-pressure pump can be easily and securely installed in the housing main body by a lower part of the high-pressure pump being held by pressure against a holding member which is provided on a bottom part of a fuel storage part of the housing main body, is formed of a resilient material, and has a flow passage communicating with the fuel storage part, in such a manner that a suction port is opened to the flow passage. In addition, a blitz type filter is provided on the holding member provided on a bottom part of a fuel storage part of the housing main body in such a manner that a feed-out port is opened to a flow passage, and a lower part of the high-pressure pump is held by pressure in such a manner that a suction port is opened to the flow passage; thus, a plurality of components can be fixed with the single holding member.

Still further, the high-pressure pump includes a connection electrode on an upper part thereof, and the connection electrode is provided to penetrate through the lid body; thus, it can be easy to install the pump and secure airtightness of the housing, whereby the number of components is reduced, and electric connection and electrical maintenance are simple. In addition, because the housing main body and the lid body are fixed to each other with a spring clip, assembly and disassembly are easy and the airtightness of the housing can be maintained.

### BRIEF DESCRIPTION OF THE SEVERAL VIEWS OF THE DRAWINGS

FIG. 1 is a perspective view showing a preferred embodiment of the present invention in a state that two types of connectors which are a first connector and a second connector are disassembled;

FIG. 2 is a perspective view showing a state that the first connector is attached;

FIG. 3 is a perspective view showing a state that the second connector is attached;

FIG. 4 is a vertical cross sectional view;

FIG. 5 is a vertical cross sectional view at a different position;

FIG. 6 is an exploded perspective view; and

FIG. 7 is a schematic diagram of a conventional fuel supply system.

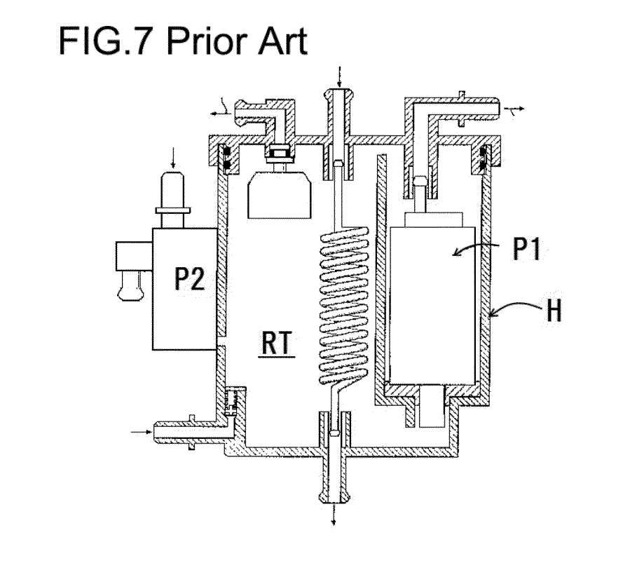

### DESCRIPTION OF A PREFERRED EMBODIMENT

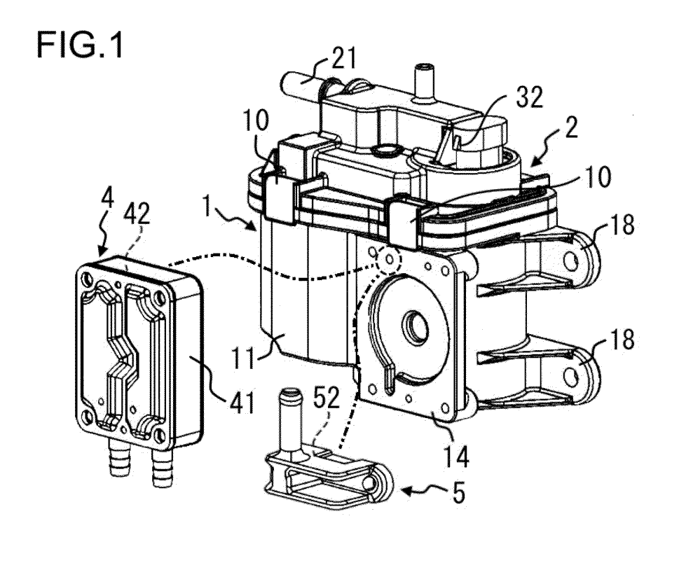

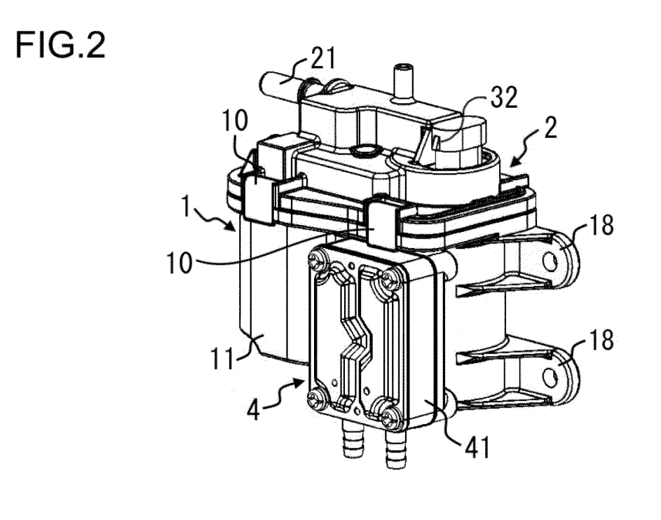

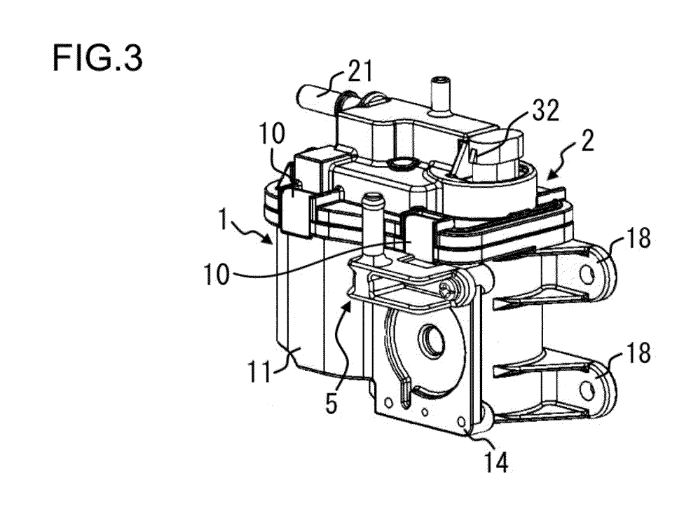

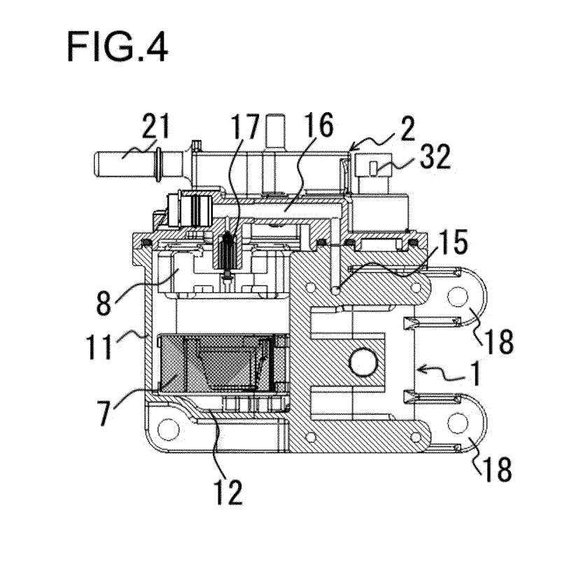

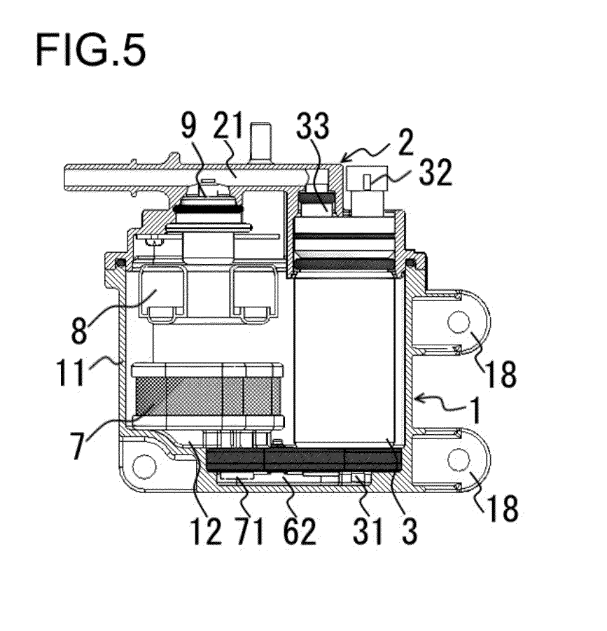

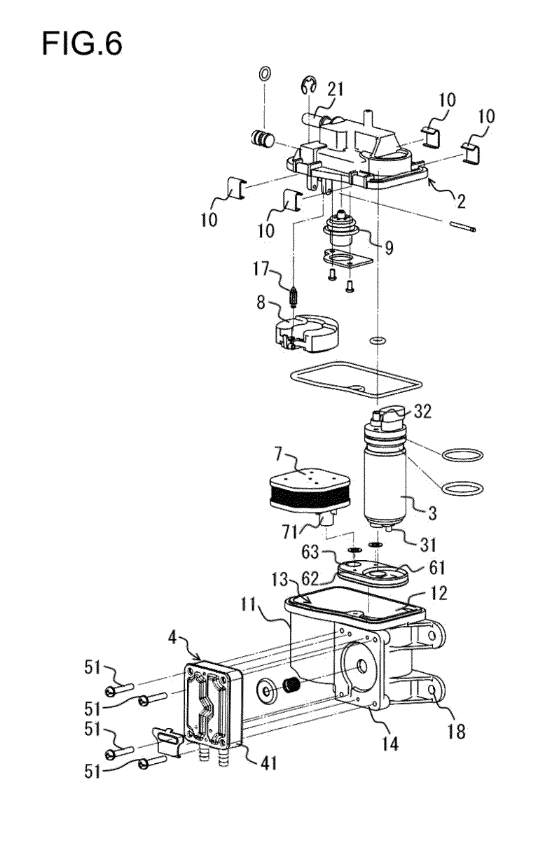

FIGS. 1 to 6 show a preferred embodiment of the present invention, and a fuel supply system as the present invention is configured with: a housing 1 which has a lid body 2 airtightly covering an opening 13 of a housing main body 11 having an opening in an upper surface, a bottom, and a fuel storage tank 12 formed therein; a high-pressure pump 3 provided in the housing main body 11 for discharging fuel stored in the fuel storage tank 12 through a fuel discharge pipe 21 formed in the lid body 2; a first connector 4 which is detachably and integrally attached on one wall surface 14 of the housing main body 11 and to which a fuel pipe (not shown) is connected from a fuel tank (not shown) and which have a low-pressure pump 41 constituted by, for example, a low-pressure diaphragm pulse pump for supplying into the fuel storage tank 12 in the housing main body 11; and a second connector 5 which is detachably and integrally attached on the one wall surface 14 of the housing main body 11 and to which a fuel pipe is connected from the fuel tank (not shown) and which have no pump for supplying into the fuel storage tank 12 in the housing main body 11. Note that the low-pressure pump 41 is a pump similar to a conventional low-pressure pump of this type in which a pulsing motion from, for example, a crankcase of the engine is used.

Thus, any one of the first connector 4 and the second connector 5 is selected and used.

In more detailed description, the high-pressure pump 3 is installed to be held by pressure and to be fit in a mounting recess 61 of a holding member 6 which is installed on the bottom part of the housing main body 11, is formed of a resilient material such as synthetic rubber, and has a flow passage 62 on a bottom part thereof communicating with the fuel storage part 12, such that a suction port 31 provided at the lower end of the high-pressure pump 3 is opened to the flow passage 62 and such that electrode part 32 formed at an upper end of the high-pressure pump 3 sticks out through the lid body 2 so that an electric connection can be made outside the housing 1.

In addition, on another mounting recess 63 which is formed on the holding member 6 and communicate with the flow passage 62, a blitz type filter 7 is also installed such that a feed-out port 71 is opened to the flow passage 62.

Further, in the wall surface 14 of the housing main body 11, a mounting part is formed to detachably attach, with a fixing bolt 51, the first connector 4 having the low-pressure pump 41 or the second connector 5, and there is formed a fuel intake port 15 with which, specifically when the first connector 4 or the second connector 5 is attached, a feed-out port 42 of the low-pressure pump 41 of the first connector 4 or a supply port 52 of the second connector 5 is airtightly fit. In addition, the fuel intake port 15 is positioned at least above a liquid surface of the fuel stored in the fuel storage tank 12, and the fuel intake port 15 communicates with the fuel storage tank 12 through a fuel passage 16 and a valve body 17 which are provided in the housing main body 11 and the lid body 2.

In the lid body 2, there is provided a float 8 for determining a liquid surface position of the fuel stored in the fuel storage tank 12. In the float 8, there is provided a regulator 9, in a penetrating manner, communicating between the fuel storage tank 12 and the fuel discharge pipe 21 which is disposed in the lid body 2 and is connected to a feed-out port 33 of the high-pressure pump 3.

In the present embodiment, the lid body 2 is fixed with a plate-like spring clip 10, and assembly and disassembly are thus easy.

The present fuel supply system having the above configuration is assembled by using any one of the first connector 4 having a low-pressure pump 41 or the second connector 5 having no pump, in accordance with the purpose of use. Of course, the connecter can be replaced with the other connector after once attached.

The assembled present embodiment is fixed to an engine, a vehicle body, or the like (not shown) via a mounting part 18 protrudingly provided on the housing 1. The fuel introduced through the first connector 4 or the second connector 5 from the fuel tank (not shown) is introduced through the fuel intake port 15 formed in the wall surface 14 of the housing main body 11 and further through the fuel passage 16 formed in the lid body 2 and the valve body 17 into the fuel storage tank 12 and is stored up to a predetermined liquid surface by the float 8. At the same time, the high-pressure pump 3 is operated to discharge the fuel in the fuel storage tank 12 through the fuel discharge pipe 21.

1. A fuel supply system comprising:
a housing configured to have a lid body airtightly covering an opening formed in an upper surface of a housing main body which forms a fuel storage tank which doubles as a reservoir, and configured to have, in a sidewall of the housing main body, a fuel intake port communicating with the fuel storage tank;
a high-pressure pump provided in the housing main body to supply fuel stored in the fuel storage tank to an engine; and
a connector which is integrally attachable to the sidewall of the housing main body, the connector including:
a fuel-feeding port configured to be in touch with and communicate with the fuel intake port formed in the wall surface when the fuel-feeding port is attached to the sidewall; and
a connection port configured to communicates with the fuel-feeding port and to accept a fuel supply pipe from a fuel tank,
wherein the connector includes a two types of connectors including a first connector having a low-pressure pump and a second connector having no pump, and wherein the two types of connectors is selectively attachable via a common connector mounting part formed on the sidewall of the housing main body.

2. The fuel supply system of claim 1, wherein in the fuel storage tank formed in the housing main body, there is provided a float equipped with an adjusting valve for keeping a liquid surface of the fuel stored in the fuel storage tank at a predetermined position.

3. The fuel supply system of claim 1, wherein the fuel intake port formed in the wall surface of the housing main body is formed above a liquid surface of the stored fuel.

4. The fuel supply system of claim 1, wherein the high-pressure pump is installed in the housing main body by a lower part of the high-pressure pump being held by pressure against a holding member which is provided on a bottom part of a fuel storage part of the housing main body, is formed of a resilient material, and has a flow passage communicating with the fuel storage part, in such a manner that a suction port is opened to the flow passage.

5. The fuel supply system of claim 1, wherein the high-pressure pump includes a connection electrode on an upper part thereof, and the connection electrode is provided to penetrate through the lid body.

6. The fuel supply system of claim 1, wherein a blitz type filter is provided on a holding member provided on a bottom part of a fuel storage part of the housing main body in such a manner that a feed-out port is opened to a flow passage, and wherein a lower part of the high-pressure pump is held by pressure in such a manner that a suction port is opened to the flow passage.

7. The fuel supply system of claim 1, wherein the housing main body and the lid body are fixed to each other with a spring clip.
